(19) United States
(12) Patent Application Publication
(10) Pub. No.: US 2022/0365931 A1
(43) Pub. Date: Nov. 17, 2022

(54) DYNAMIC DEGREE OF QUERY PARALLELISM OPTIMIZATION

(71) Applicant: International Business Machines Corporation, Armonk, NY (US)

(72) Inventors: Gaurav Mehrotra, Pune (IN); Calisto Zuzarte, Pickering (CA); Bhavesh Rathore, Pune (IN); Abhishek Iyer, Newark, CA (US)

(21) Appl. No.: 17/320,510

(22) Filed: May 14, 2021

(51) Int. Cl. G06F 16/2453; G06F 9/50; G06F 9/455

(52) U.S. Cl. CPC G06F 16/24532; G06F 9/5027; G06F 9/45558

(57) ABSTRACT

Approaches presented herein enable dynamic optimization of a degree to which a query is parallelized for execution. More specifically, a priority associated with an obtained user query for execution is identified. A real-time metric indicating availability of one or more runtime resources is checked. An optimal degree of parallelism is calculated based on the priority associated with the obtained user query and the real-time availability metric. A plan is generated for executing the query using the calculated optimal degree of parallelism.

### TECHNICAL FIELD

The present invention relates generally to search query processing and, more specifically, to dynamically optimizing the degree a query is parallelized for execution based on user workload definitions and availability of system resources during runtime.

### BACKGROUND

The networked computing environment (e.g., cloud computing environment) is an enhancement to the predecessor grid environment, whereby multiple grids and other computation resources may be further enhanced by one or more additional abstraction layers (e.g., a cloud layer), thus making disparate devices appear to an end-consumer as a single pool of seamless resources. These resources may include such things as physical or logical computing engines, servers and devices, device memory, and storage devices, among others.

Providers in the networked computing environment often deliver services online via a remote server, which can be accessed via a web service and/or software, such as a web browser. Individual clients can run virtual machines (VMs) that utilize these services and store the data in the networked computing environment. This can allow a single physical server to host and/or run many VMs simultaneously.

Components of a task, such as a database query, can be run in parallel across several resources to enhance performance. Types of parallelism can include input/output (I/O) parallelism, query parallelism, and utility parallelism. In I/O parallelism, two or more I/O devices can be written to and/or read from simultaneously.

Query parallelism can take the form of interquery parallelism or intraquery parallelism. Interquery parallelism is a process by which a database accepts queries from multiple applications at the same time, while intraquery parallelism refers to simultaneous processing of parts of a single query, using either intrapartition parallelism, interpartition parallelism, or a combination of the two.

In intrapartition parallelism, a query is broken up into multiple parts, subdividing what is typically considered to be a single database operation (e.g., index creation, database loading, or Structured Query Language (SQL) queries) into multiple pieces, many or all of which can be run in parallel within a single database partition. The pieces are copies of each other and the number of pieces of a query running in parallel is represented by that query's degree of parallelism. Such intrapartition parallelism allows results to be returned more quickly than if the query were run in serial fashion.

By contrast, interpartition parallelism refers to breaking up a query or other single operation into multiple parts across multiple partitions of a partitioned database, on one machine or multiple machines and then running each part in parallel on one of the partitions. Sometimes, intrapartition parallelism is combined with interpartition parallelism to permit a query or other single operation to be split into multiple parts which are run on each partition across multiple partitions.

Utility parallelism takes advantage of I/O parallelism and the intrapartition and interpartition parallelism of intraquery parallelism to run utilities (e.g., loan commands, index creation, backup and restore operations) more efficiently across multiple database partitions.

### SUMMARY

Approaches presented herein enable dynamic optimization of a degree to which a query is parallelized for execution. More specifically, a priority associated with an obtained user query for execution is identified. A real-time metric indicating availability of one or more runtime resources is checked. An optimal degree of parallelism is calculated based on the priority associated with the obtained user query and the real-time availability metric. A plan is generated for executing the query using the calculated optimal degree of parallelism.

One aspect of the present invention includes a method for dynamically optimizing a degree to which a query is parallelized for execution, comprising: identifying a priority associated with an obtained user query for execution; checking a real-time metric indicating availability of one or more runtime resources; calculating an optimal degree of parallelism based on the priority associated with the obtained user query and the real-time availability metric; and generating a plan for executing the query using the calculated optimal degree of parallelism.

Another aspect of the present invention includes a computer system for dynamically optimizing a degree to which a query is parallelized for execution, the computer system comprising: a memory medium comprising program instructions; a bus coupled to the memory medium; and a processor, for executing the program instructions, coupled to a dynamic query degree optimization engine via the bus that when executing the program instructions causes the system to: identify a priority associated with an obtained user query for execution; check a real-time metric indicating availability of one or more runtime resources; calculate an optimal degree of parallelism based on the priority associated with the obtained user query and the real-time availability metric; and generate a plan for executing the query using the calculated optimal degree of parallelism.

Yet another aspect of the present invention includes a computer program product for dynamically optimizing a degree to which a query is parallelized for execution, the computer program product comprising a computer readable hardware storage device, and program instructions stored on the computer readable hardware storage device, to: identify a priority associated with an obtained user query for execution; check a real-time metric indicating availability of one or more runtime resources; calculate an optimal degree of parallelism based on the priority associated with the obtained user query and the real-time availability metric; and generate a plan for executing the query using the calculated optimal degree of parallelism.

Still yet, any of the components of the present invention could be deployed, managed, serviced, etc., by a service provider who offers to implement passive monitoring in a computer system.

Embodiments of the present invention also provide related systems, methods, and/or program products.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 depicts an architecture in which the invention may be implemented according to illustrative embodiments of the present invention.

FIG. 2 depicts a cloud computing environment according to illustrative embodiments of the present invention.

FIG. 3 depicts abstraction model layers according to illustrative embodiments of the present invention of the present invention.

FIG. 4 depicts a system diagram describing the functionality discussed herein according to illustrative embodiments of the present invention.

FIG. 5 depicts a method for dynamically optimizing a degree to which a query is parallelized for execution according to illustrative embodiments.

FIG. 6 depicts a process flowchart for dynamically optimizing a degree to which a query is parallelized for execution according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide for dynamic optimization of a degree to which a query is parallelized for execution. More specifically, a priority associated with an obtained user query for execution is identified. A real-time metric indicating availability of one or more runtime resources is checked. An optimal degree of parallelism is calculated based on the priority associated with the obtained user query and the real-time availability metric. A plan is generated for executing the query using the calculated optimal degree of parallelism.

It is to be understood that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

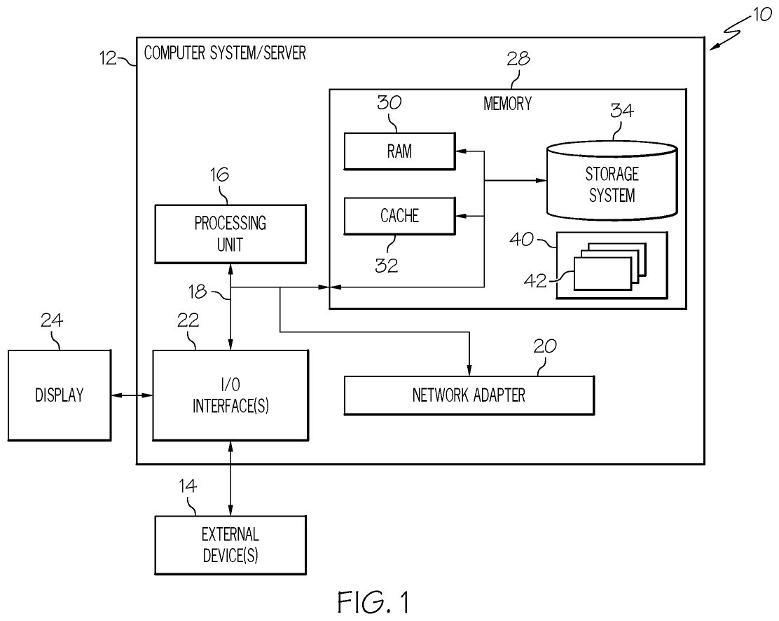

Referring now to FIG. 1, a schematic of an example of a cloud computing node for dynamically optimizing a degree to which a query is parallelized for execution will be shown and described. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 is intended to represent any type of computer system/server that may be implemented in deploying/realizing the teachings recited herein. Computer system/server 12 may be described in the general context of computer system/server executable instructions, such as program modules, being executed by a computer system. Generally, program modules may include routines, programs, objects, components, logic, data structures, and so on, that perform particular tasks or implement particular abstract data types. In this particular example, computer system/server 12 may be practiced in distributed cloud computing environments where tasks are performed by remote processing devices that are linked through a communications network. In a distributed cloud computing environment, program modules may be located in both local and remote computer system storage media including memory storage devices.

Computer system/server 12 in cloud computing node 10 is shown in the form of a computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as program code for dynamically optimizing a degree to which a query is parallelized for execution, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and/or an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radiofrequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to, microcode, device drivers, redundant processing units, external disk drive arrays, RAID systems, tape drives, and data archival storage systems, etc.

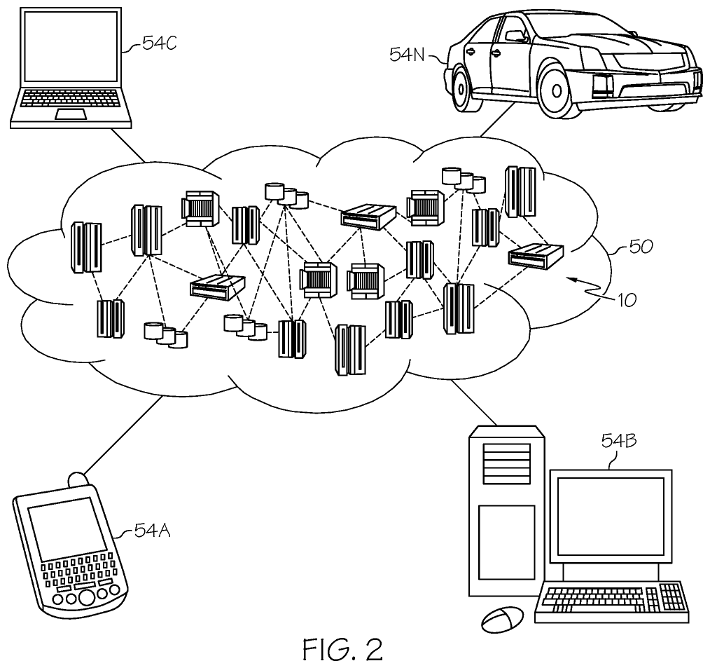

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

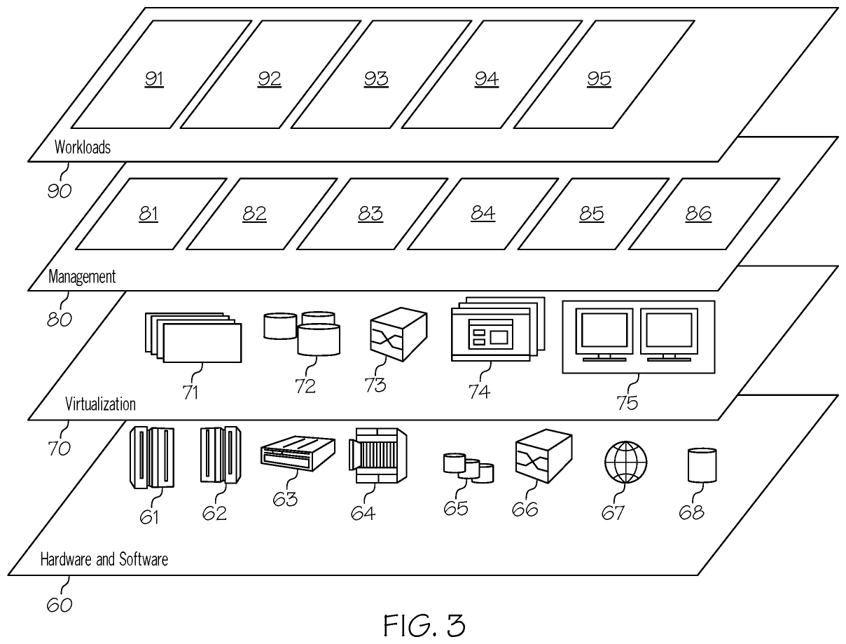

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA. Dynamically optimizing query degree 86 performs embodiments of the present invention as will be described in further detail below.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; and transaction processing 95. As mentioned above, all of the foregoing examples described with respect to FIG. 3 are illustrative only, and the invention is not limited to these examples.

It is understood that all functions of the present invention as described herein typically may be performed by the dynamic query degree optimization 86 functionality (of management layer 80, which can be tangibly embodied as modules of program code 42 of program/utility 40 (FIG. 1)). However, this need not be the case. Rather, the functionality recited herein could be carried out/implemented and/or enabled by any of the layers shown in FIG. 3.

It is reiterated that although this disclosure includes a detailed description on cloud computing, implementation of the teachings recited herein are not limited to a cloud computing environment. Rather, some embodiments of the present invention are intended to be implemented with any type of networked computing environment now known or later developed.

Embodiments of the present invention recognize that many computer database systems use parallelized execution in order to execute a query faster. Such systems currently define the degree of parallelism by a static algorithm that checks the resources available on the system on which the database is running. While the degree of parallelism can be altered manually by a database administrator to control usage of system resources, currently there is no mechanism to help prioritize the parallel execution of a query. Furthermore, in some systems, users can specify a degree to which a query is parallelized for a workload class, but such specification is static and does not consider the available resources of the system on which the query is to be run.

Accordingly, embodiments of the present invention utilize a system that integrates query optimization code with workload management (WLM). Embodiments of the present invention check for user workload definition in addition to availability of system resources while preparing a query execution plan. If the workload is classified as above a normal threshold (e.g., high or critical), then, based on available system resources for runtime, embodiments can calculate an optimal degree of parallelism that takes into account both workload needs and system limitations. Similarly, if the workload is classified as below a normal threshold (e.g., low priority), then embodiments can more readily decrease a degree of parallelism responsive to limited resource availability. As such, embodiments of the present invention permit the generation of a more optimal explain plan for execution.

Furthermore, embodiments of the present invention offer several advantages for dynamically optimizing a degree to which a query is parallelized for execution over the current art by taking runtime available resources into consideration. More specifically, embodiments of the present invention permit a query optimization system to consider elements, such as a real-time concurrent execution in a system, queue length under a defined workload, and an availability of an operating system (OS), central processing system (CPU), or memory resource, in addition to a user-defined workload definition.

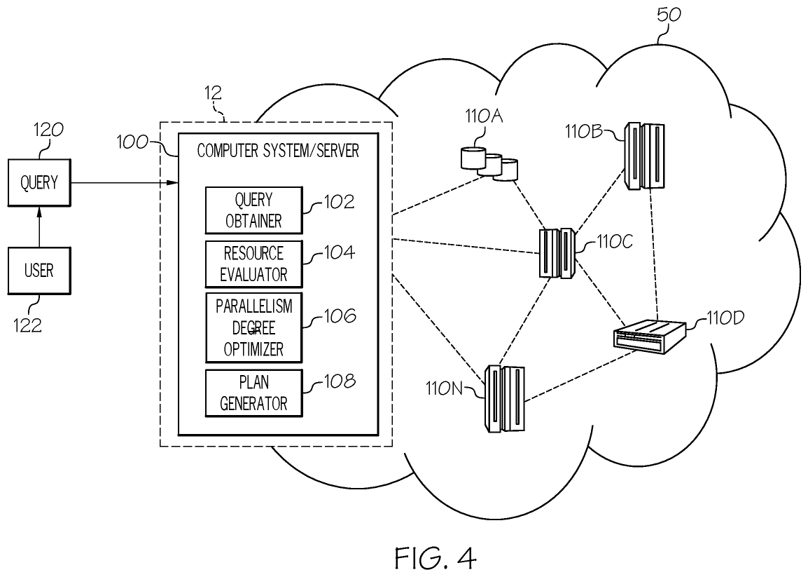

Referring now to FIG. 4, a system diagram describing the functionality discussed herein according to an embodiment of the present invention is shown. A stand-alone computer system/server 12 is shown in FIG. 4 for illustrative purposes only. In the event the teachings recited herein are practiced in a networked computing environment, each client need not have a dynamic query degree optimization engine 100 (hereinafter “system 100”). Rather, all or part of system 100 could be loaded on a server or server-capable device that communicates (e.g., wirelessly) with the clients to provide for dynamic optimization of a degree to which a query is parallelized for execution. Regardless, as depicted, system 100 is shown within computer system/server 12. In general, system 100 can be implemented as program/utility 40 on computer system 12 of FIG. 1 and can enable the functions recited herein.

Among other functions, system 100 can dynamically optimize a degree to which a query is parallelized for execution in a networked or cloud computing environment. To accomplish this, system 100 can include a set of components (e.g., program modules 42 of FIG. 1) for carrying out embodiments of the present invention. These components can include, but are not limited to, query obtainer 102, resource evaluator 104, parallelism degree optimizer 106, and plan generator 108.

Through computer system/server 12, system 100 can be in communication with resources/nodes 110A-N in network/cloud computing environment 50, such as mainframes, RISC architecture-based servers and other servers, storage devices 65, and networks and networking components. Furthermore, system 100 can be in communication with virtual machines running in network/cloud computing environment 50, such as those running network application server software and database software.

Through computer system/server 12, system 100 can receive/obtain an operation for execution within network/cloud computing environment 50, such as a query 120 in an SQL format, from a user 122 of network/cloud computing environment 50.

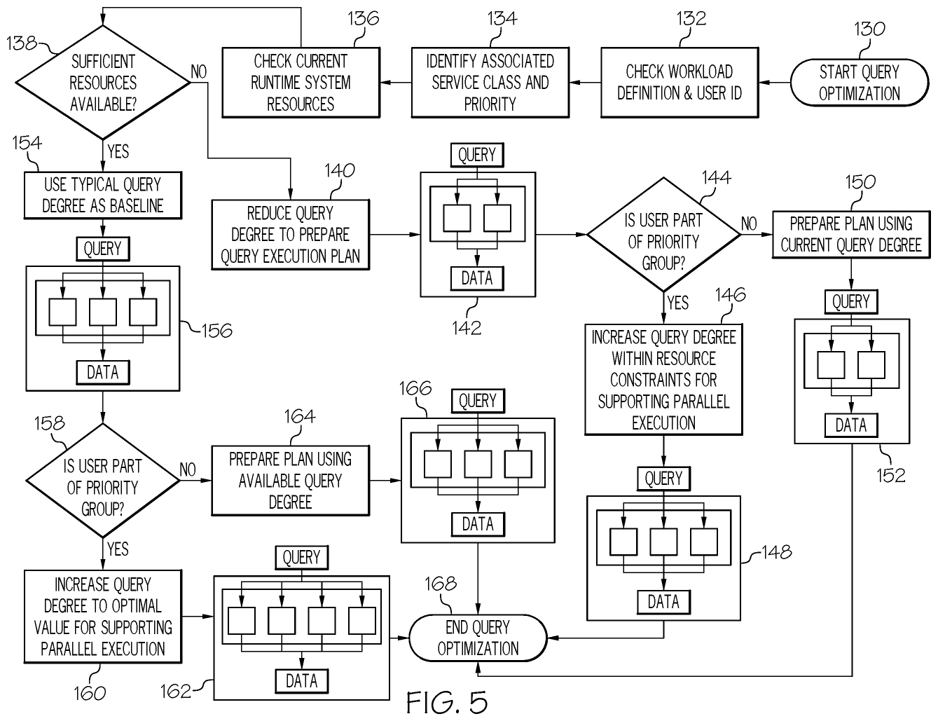

Referring now to FIG. 5 in connection with FIG. 4, a method for dynamically optimizing a degree to which a query is parallelized for execution according to some embodiments of the present invention is shown and described in further detail. It is understood that a complier, such as an SQL compiler, generally works in three broad steps before to prepare and send a query for execution. Typically, the complier first parses the query and then performs a semantic check. Assuming the query satisfies the requirements of these first two steps, the complier then performs a query optimization process. It is this query optimization process 130 on which embodiments of the present invention focus. Embodiments of the present invention will improve traditional compliers with the novel ability to contemplate, during the query optimization step, the availability of runtime resources when calculating an optimal query degree and, based on this calculated query degree, to create an explain plan for the execution of the query.

Therefore, according to embodiments of the present invention, query obtainer 102, as performed by computer system/server 12, can obtain a query 120 for execution from user 122 and identify a priority associated with query 120. According to some embodiments, query 120 can be an SQL query for execution on a database. According to some other embodiments, query 120 can more generally be any operation for execution, for example a data retrieval request, within a computing environment and should not be construed as merely limited to an SQL query, except for where indicated by context.

Regardless, query obtainer 102 can also obtain, in addition to or as part of, query 120, a workload definition of query 120 and information such as an identification (ID) of user 122 at block 132. At block 134, query obtainer 102 can use this user identification and/or workload definition to classify query 120 and/or determine a priority for query 120. For example, in some embodiments, user 122 is mapped to certain workloads which are assigned a category (e.g., critical, high, normal, low). In other embodiments, a type (e.g., organization user or operational user) of user that user 122 is can have a certain priority associated therewith. In still other embodiments, a workload definition of query 120 can have a certain priority associated therewith. For example, priority may be based on a number of rows or other organizational structure in query 120.

Priority of query 120 can be measured in any manner presently in use or later developed. For example, in some embodiments, priority can be classified relative to predetermined thresholds, where “low” corresponds to a priority value below a predetermined threshold, “high” corresponds to a priority value above another predetermined threshold, and “normal/medium” corresponds to a priority value between the high and low thresholds. Additional nuances on this scale can also be added, such as “critical” at some threshold above the predetermined high threshold and “minor” at some threshold below the predetermined low threshold. In still other embodiments, on a system in which a query degree of parallelism ranges from zero (0) to ten (10), priority can likewise be assigned on a degree of zero (0) to ten (10). In still other embodiments, priority can be on some other scale, such as a numerical scale or percentage scale.

It should be understood that, while some traditional compilers may specify a query degree of parallelization for a particular workload, such query degree is static to the workload/query. By contrast, while embodiments of the present invention may determine an initial query degree based on workload class, this initial query degree is subject to change based on an availability of runtime resources and other runtime constraints, as will be discussed in more detail below.

According to embodiments of the present invention, resource evaluator 104, as performed by computer system/server 12, can check a real-time availability of one or more runtime resources 110A-N at block 136. In some embodiments, resource evaluator 104 can accomplish this by checking a real-time metric indicating an availability of one or more runtime resources 110A-N. This real-time availability metric can describe system performance and/or capacity information, such as, but not limited to, a measure of current concurrent execution in a computing system/cloud computing environment 50, a metric describing current queue length under various defined workloads in the computing system/cloud computing environment 50, and/or a metric describing an availability of an OS, CPU or memory resource of the computing system/cloud computing environment 50. It should be understood that resource availability as used herein refers to the capability of a running resource to handle a workload, and not merely to whether a resource is switched on or off.

Current concurrent execution is a measure of how many multiple users are currently accessing and/or using a same database or other system at one time. Current queue length is a number of requests outstanding on a database or other system at a time performance data is collected; if a system has a queue length, that system is not able to honor I/O requests as fast as they are being made. An availability, as used herein, refers to resources available for running a database or other computer system. Although embodiments of the present invention will be described herein with reference to these specific runtime resources, it is to be understood that other runtime resources and metrics for measuring them are also within the scope if the present invention.

In any case, once resource evaluator 104 obtains a real-time metric indicative of availability of one or more runtime resources 110A-N, resource evaluator 104 can determine at block 138 whether sufficient runtime resources 110A-N are available to handle query 120. To accomplish this, resource evaluator 104 can evaluate query 120 to determine a type, capacity, and/or duration, etc. of resources that will be required to execute query 120 in parallel. In some embodiments, resource evaluator 104 may make an initial query degree for query 120 based on the query definition of query 120 in order to perform this evaluation. Resource evaluator 104 may use historical data for network/cloud computing environment 50 or a particular such runtime environment as the basis for the execution resources projection. That is to say, historical executions of similar queries with similar degrees of parallelization can provide comparables from which to estimate the resources that will be needed to execute query 120.

Furthermore, in some embodiments, system 100 may be configured to receive a plurality of queries 120 from one or more users 122 at about the same time, permitting a group of such queries 120 to be executed essentially simultaneously in network/cloud computing runtime environment 50. In such embodiments, where a plurality of queries 120 are processed together, resource evaluator 104 can generate a resource requirement projection for execution of the plurality of queries 120. As will be described in greater detail below, system 100 can use this projection to adjust the degrees of each query 120 so that the batch of queries can be run within the constraints of network/cloud computing runtime environment 50.

In any case, resource evaluator 104 can compare the real-time metric indicative of availability of one or more runtime resources 110A-N against the projected resources needed for execution of one or more queries 120. Based on this comparison, resource evaluator 104 can determine whether there are sufficient, insufficient, or more than sufficient runtime resources available for executing the one or more queries 120. System 100 can then, as described in more detail below, integrate this resource availability information into its process of determining an optimal degree of parallelization for each query 120, thereby marrying workload management (WLM) with query optimisation code.

According to embodiments of the present invention, parallelism degree optimizer 106, as performed by computer system/server 12, can calculate an optimal degree of parallelism based on the priority associated with obtained user query 120 and the real-time availability metric. To accomplish this, parallelism degree optimizer 106 can use the resource availability determination from resource evaluator 104 as a preliminary indicator of about how many degrees of parallelization are feasible within the resource availability constraints of network/cloud computing runtime environment 50. In other words, parallelism degree optimizer 106 can start with a number of degrees of parallelism appropriate for the resource availability and then modify the number of degrees up or down based on other optimization parameters, namely a priority of the query.

In some computer systems, the degrees of parallelization for a given query can be an integer selected between zero (0) and ten (10). In still other embodiments, degrees of parallelization can be on some other scale, such as a numerical scale or percentage scale. In any case, in embodiments of the present invention, the degrees of parallelization for a given query can be an integer selected from a range of integers, wherein a quantity of available integers is at least equal to or greater than three. Parallelism degree optimizer 106 can increment the number of degrees a query is parallelized up or down by one or more integers. For example, in response to a query having a high priority, parallelism degree optimizer 106 can increment the query's degree from an initial degree based on workload definition of the query, e.g. 3, up to a higher degree, e.g., 4. Parallelism degree optimizer 106 is not limited to incrementing the query by a single degree, although this may be the case in some embodiments. For instance, continuing the above example, parallelism degree optimizer 106 could increase the query degree from 3 to 5 or more in response to a high priority.

For example, at block 140, parallelism degree optimizer 106 can use the fact that there are insufficient resources available to execute query 120 with as many degrees of parallelism as would typically be desired to instead decrease the number of degrees of parallelism relative to the number of degrees parallelism degree optimizer 106 would (under good resource availability circumstances) recommend using, as seen by way of example at block 142. Then at block 144, parallelism degree optimizer 106 can use the determination made by query obtainer 102 as to whether query 120 and/or user 122 associated with query 120 has a specialized status, based on user identification and/or workload definition as discussed above, to prioritize or de-prioritize, as the case may be, query 120. In the case that query 120 has a priority status above a predetermined threshold (e.g., high priority, critical priority), parallelism degree optimizer 106 can, at block 146, increase the number of degrees of parallelism relative to the number of degrees determined at block 140, as seen by way of example at block 148. On the other hand, in the case that query 120 has a non-priority status (e.g., typical priority), parallelism degree optimizer 106 can, at block 150, maintain the number of degrees of parallelism determined at block 140 responsive to the lack of sufficient resources, as seen by way of example at block 152. Although not shown in FIG. 5, in the case that query 120 has a priority status below a predetermined threshold (e.g., low priority, non-critical), parallelism degree optimizer 106 can maintain or further decrease the number of degrees of parallelism from that determined at block 140.

However, continuing the example, at block 154, parallelism degree optimizer 106 can, responsive to the fact that there are sufficient resources available to execute query 120 with as many degrees of parallelism as would typically be desired, use this typically expected number of degrees as an initial baseline for number of degrees, as seen by way of example at block 156. Then at block 158, parallelism degree optimizer 106 can use the determination made by query obtainer 102 as to whether query 120 and/or user 122 associated with query 120 has a specialized status, based on user identification and/or workload definition as discussed above, to prioritize or de-prioritize, as the case may be, query 120. In the case that query 120 has a priority status above a predetermined threshold (e.g., high priority, critical priority), parallelism degree optimizer 106 can, at block 160, increase the number of degrees of parallelism relative to the number of degrees used as baseline at block 154, as seen by way of example at block 162. In contrast, in the case that query 120 has a non-priority status (e.g., typical priority), parallelism degree optimizer 106 can, at block 164, maintain the number of degrees of parallelism determined as a baseline at block 154 responsive to the availability of sufficient resources, as seen by way of example at block 166. Although not shown in FIG. 5, in the case that query 120 has a priority status below a predetermined threshold (e.g., low priority, non-critical), parallelism degree optimizer 106 can maintain or further decrease the number of degrees of parallelism from that determined as baseline at block 154.

Furthermore, continuing the same example, in the case that there are more than sufficient resources available, parallelism degree optimizer 106 can be configured to increase the number of degrees of parallelism for query 120 beyond the baseline number, even if query 120 lacks a priority indicative of such an increase. For example, in the case that query 120 comes from an operational user and has only medium priority (i.e., no specialized priority), but resource evaluator 104 has determined that some resources are idle resources, parallelism degree optimizer 106 bumps up the degree of parallelization for query 120 if doing so would better optimize its run. In other words, in some embodiments, parallelism degree optimizer 106 can increase the number of degrees of parallelism for query 120 in order to most take advantage of otherwise idle resources.

According to some embodiments of the present invention, parallelism degree optimizer 106 can balance resource needs of a plurality of queries 120 to be executed at substantially the same time. To accomplish this, parallelism degree optimizer 106 can increase the degree of parallelization of a query having an elevated priority while, hand-in-hand, also decreasing the degree of parallelization of a query having a low priority. Particularly when resource availability is limited, resource evaluator 104 can set an adjustable degree of parallelism to an initial degree of parallelism for each query 120 of the plurality, and then parallelism degree optimizer 106 can adjust degrees for some queries up or down, as priority may indicate, while keeping the batch of queries within resource availability limits. Such balancing can be performed to ensure that the degree of parallelization assigned to each query 120 of the plurality of queries in summation are within the resource availability limitations of network/cloud computing runtime environment 50.

It should be understood that, according to some embodiments of the present invention, query obtainer 102 can continue to obtain other queries while system 100 is processing query 120 and/or while query 120 is in the process of executing. Also, resource evaluator 104 can continue to check (e.g., continuously, periodically) resource availability while system 100 is processing query 120 and/or while query 120 is in the process of executing. This allows not only the parallelization of query 120 to be dynamically adjusted, but also prevents the effects of higher or lower resource availability and/or the introduction of higher or lower priority queries from falling solely on subsequent queries. As such, the parallelization of a lower priority query that is in the process of executing can be adjusted in order to make more resources available in the case that higher priority queries are introduced. Similarly, if new resources come online or otherwise become available while a query is in the process of executing, the number of degrees that that query is parallelized can be adjusted upward due to the increased resources available. Likewise, if a resource goes offline or otherwise becomes unavailable while a query is in the process of executing, the number of degrees that that query is parallelized can be adjusted downward due to the decreased resources available. As such, according to some embodiments of the present invention, generated explain plans, discussed below, can be dynamically updated to reflect potential changes in resource availability.

According to embodiments of the present invention, plan generator 108, as performed by computer system/server 12, can generate a plan for executing the query using the calculated optimal degree of parallelism. Once parallelism degree optimizer 106 finalizes the selection of an optimal degree of parallelization for query 120 at block 168, plan generator 108 can use this selected degree to create an explain plan for the execution of query 120 in network/cloud computing runtime environment 50. As such, the explain plan generated for query 120 reflects both query optimization and workload management considerations. Once plan generator 108 has created an explain plan for the execution of query 120, compilation of query 120 is completed and system 100 can send query 120 for execution in network/cloud computing runtime environment 50.

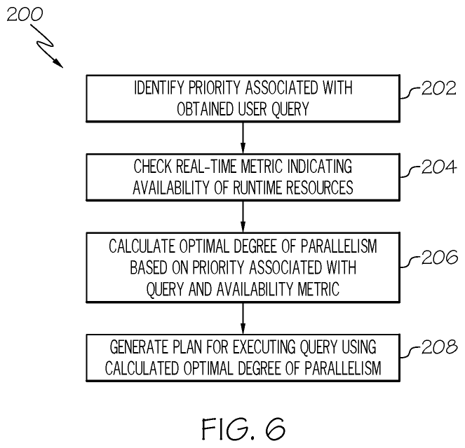

As depicted in FIG. 6, in one embodiment, a system (e.g., computer system/server 12) carries out the methodologies disclosed herein. Shown is a process flowchart 200 for dynamically optimizing a degree to which a query is parallelized for execution. At 202, query obtainer 102 identifies a priority associated with an obtained user query 120 for execution. At 204, resource evaluator 104 checks a real-time metric indicating availability of one or more runtime resources 110A-N. At 206, parallelism degree optimizer 106 calculates an optimal degree of parallelism based on the priority associated with obtained user query 120 and the real-time availability metric. At 208, plan generator 108 generates a plan for executing query 120 using the calculated optimal degree of parallelism.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for dynamically optimizing a degree to which a query is parallelized for execution. Thus, embodiments herein disclose a process for supporting computer infrastructure, comprising integrating, hosting, maintaining, and deploying computer-readable code into a computing system (e.g., computer system/server 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for dynamically optimizing a degree to which a query is parallelized for execution. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is apparent that there has been provided herein approaches to dynamically optimize a degree to which a query is parallelized for execution. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

1. A method for dynamically optimizing a degree to which a query is parallelized for execution, comprising:
obtaining a batch of user queries, the batch comprising a plurality of user queries for execution;
identifying a priority associated with at least one of the obtained user queries for execution;
checking a real-time metric indicating availability of one or more runtime resources;
calculating an optimal degree of parallelism based on the priority associated with the at least one obtained user query and the real-time availability metric;
balancing degrees of parallelism between individual queries in the batch such that priority queries are assigned optimal degrees of parallelism within the availability of the one or more runtime resources; and
generating a plan for executing the batch of queries using balanced and assigned optimal degrees of parallelism.

2. The method of claim 1, the method further comprising obtaining a workload definition of the at least one query.

3. The method of claim 2, the calculating an optimal degree of parallelism further comprising:
setting an adjustable degree of parallelism value to an initial degree of parallelism based on the workload definition of the at least one query;
decreasing the adjustable degree of parallelism by at least one degree responsive to the real-time metric being below a pre-determined threshold;
increasing the adjustable degree of parallelism by at least one degree responsive to the priority being above a pre-determined threshold; and
decreasing the adjustable degree of parallelism by at least one degree responsive to the priority being below a pre-determined threshold.

4. The method of claim 1, wherein the real-time availability metric is selected from the group consisting of: a metric describing concurrent execution in a system, a metric describing current queue length under a defined workload, and a metric describing an availability of an operating system (OS), central processing system (CPU), or memory resource.

5. The method of claim 1, the calculating further comprising decreasing a degree of parallelism responsive to an insufficient real-time availability metric.

6. The method of claim 1, wherein the priority is a classification selected from the group consisting of: low, normal, high, and critical, and wherein the calculating further comprises:
increasing a degree of parallelism responsive to a high or critical priority; and
decreasing a degree of parallelism responsive to a low priority.

7. The method of claim 1, the calculating an optimal degree of parallelism further comprising adjusting a degree of parallelism of another query in the batch in a direction opposite to a change in a degree of parallelism of the at least one user query, responsive to the other query having a different priority than the at least one user query.

8. A computer system for dynamically optimizing a degree to which a query is parallelized for execution, the computer system comprising:
a memory medium comprising program instructions;
a bus coupled to the memory medium; and
a processor, for executing the program instructions, coupled to a dynamic query degree optimization engine via the bus that when executing the program instructions causes the system to:
obtain a batch of user queries, the batch comprising a plurality of user queries for execution;
identify a priority associated with at least one of the obtained user queries for execution;
check a real-time metric indicating availability of one or more runtime resources;
calculate an optimal degree of parallelism based on the priority associated with the at least one obtained user query and the real-time availability metric;
balance degrees of parallelism between individual queries in the batch such that priority queries are assigned optimal degrees of parallelism within the availability of the one or more runtime resources; and
generate a plan for executing the batch of queries using balanced and assigned optimal degrees of parallelism.

9. The computer system of claim 8, the instructions further causing the system to obtain a workload definition of the at least one query.

10. The computer system of claim 9, wherein the instructions causing the system to calculate the optimal degree of parallelism further comprise instructions causing the system to:
set an adjustable degree of parallelism value to an initial degree of parallelism based on the workload definition of the at least one query;
decrease the adjustable degree of parallelism by at least one degree responsive to the real-time metric being below a pre-determined threshold;
increase the adjustable degree of parallelism by at least one degree responsive to the priority being above a pre-determined threshold; and
decrease the adjustable degree of parallelism by at least one degree responsive to the priority being below a pre-determined threshold.

11. The computer system of claim 8, wherein the real-time availability metric is selected from the group consisting of: a metric describing concurrent execution in a system, a metric describing current queue length under a defined workload, and a metric describing an availability of an operating system (OS), central processing system (CPU), or memory resource.

12. The computer system of claim 8, the instructions further causing the system to decrease a degree of parallelism responsive to an insufficient real-time availability metric.

13. The computer system of claim 8, wherein the priority is a classification selected from the group consisting of: low, normal, high, and critical, and wherein the instructions further cause the system to:
increase a degree of parallelism responsive to a high or critical priority; and
decrease a degree of parallelism responsive to a low priority.

14. The computer system of claim 8, the instructions further causing the system to adjust a degree of parallelism of another query in the batch in a direction opposite to a change in a degree of parallelism of the at least one user query, responsive to the other query having a different priority than the at least one user query.

15. A computer program product for dynamically optimizing a degree to which a query is parallelized for execution, the computer program product comprising a computer readable hardware storage device, and program instructions stored on the computer readable hardware storage device, to:
obtain a batch of user queries, the batch comprising a plurality of user queries for execution;
identify a priority associated with at least one of the obtained user queries for execution;
check a real-time metric indicating availability of one or more runtime resources;
calculate an optimal degree of parallelism based on the priority associated with the at least one obtained user query and the real-time availability metric;
balance degrees of parallelism between individual queries in the batch such that priority queries are assigned optimal degrees of parallelism within the availability of the one or more runtime resources; and
generate a plan for executing the batch of queries using balanced and assigned optimal degrees of parallelism.

16. The computer program product of claim 15, the computer readable storage device further comprising instructions to obtain a workload definition of the at least one query.

17. The computer program product of claim 16, wherein the instructions to calculate the optimal degree of parallelism further comprise instructions to:
set an adjustable degree of parallelism value to an initial degree of parallelism based on the workload definition of the at least one query;
decrease the adjustable degree of parallelism by at least one degree responsive to the real-time metric being below a pre-determined threshold;
increase the adjustable degree of parallelism by at least one degree responsive to the priority being above a pre-determined threshold; and
decrease the adjustable degree of parallelism by at least one degree responsive to the priority being below a pre-determined threshold.

18. The computer program product of claim 15, wherein the real-time availability metric is selected from the group consisting of: a metric describing concurrent execution in a system, a metric describing current queue length under a defined workload, and a metric describing an availability of an operating system (OS), central processing system (CPU), or memory resource.

19. The computer program product of claim 15, wherein the priority is a classification selected from the group consisting of: low, normal, high, and critical, and wherein the computer readable storage device further comprises instructions to:
increase a degree of parallelism responsive to a high or critical priority; and
decrease a degree of parallelism responsive to a low priority.

20. The computer program product of claim 15, the computer readable storage device further comprising instructions to adjust a degree of parallelism of another query in the batch in a direction opposite to a change in a degree of parallelism of the at least one user query, responsive to the other query having a different priority than the at least one user query.
